(19) United States
(12) Patent Application Publication
(10) Pub. No.: US 2026/0110993 A1
(43) Pub. Date: Apr. 23, 2026

(54) Method for the design of adaptive autopilot controllers for flying objects under varying velocity, altitude and overload conditions

(71) Applicant: VIETTEL GROUP, Ha Noi City (VN)

(72) Inventors: THI DIEU LINH DANG, Ha Noi City (VN); KIEM CHIEN NGUYEN, Ha Noi City (VN)

(73) Assignee: VIETTEL GROUP, Ha Noi City (VN)

(21) Appl. No.: 19/335,724

(22) Filed: Sep. 22, 2025

(30) Foreign Application Priority Data
Oct. 17, 2024 (VN) 1-2024-07808

(51) Int. Cl. G05B 13/04; B64F 5/60

(52) U.S. Cl. CPC G05B 13/04; B64F 5/60

(57) ABSTRACT

The method for designing an autopilot controller for flying objectives (FOs) that adapts to velocity, altitude, and overload consists of two parts: part I focuses on determining the initial controller, and part II focuses on determining the adaptive controller. This method eliminates transfer function zeros, prevents continuous integration, and limits the control signal to ensure the operational conditions of the control loops. The use of a unified control structure allows for a consistent design and tuning process across all three control channels, thereby generalizing the control problem. The solution ensures strong adaptability across a wide range of flight scenarios for FOs, particularly those operating at high velocities, with high overload, and continuously changing altitudes.

### TECHNICAL FIELDS

The invention relates to a method for designing autopilot controllers for flying objects (FO) that is adaptable to variation in velocity, altitude and overload. In particular, the method is employed in designing control gains for unmanned aerial vehicles (UAVs) and high-tech weapons (HTWs) characterized by high speeds, rapid maneuverability and continuously varying altitudes. This method is applicable to various types of FOs, from subsonic to supersonic speeds, especially those requiring high maneuverability, overload capacity and operation at varying altitudes with rapid and continuous altitude changes.

### TECHNICAL STATUS OF INVENTION

According to the FO's functional configuration, the autopilot is considered the brain of the FO, responsible for calculating control signals to guide the FO to destroy targets. To achieve this objective, a three-loop controller is designed, in which two inner loops control angular velocity and one outer loop controls the error between the reference signal and the feedback signal to zero. During the flight process, the FO continuously changes in mass, center of gravity, moment of inertia, speed, altitude, required overload, angle of attack, side-slip angle, etc. All these parameters are generally termed as flight conditions or flight contexts. The three-loop autopilot controller consists of four main gains, denoted as q=[K_{DC}, K_{A}, K_{I}, K_{R}], which are calculated at a specific flight condition. To adapt to a wide range of different flight contexts, the controller's gains must change to meet the predefined design criteria. Adjusting the control gains for each flight condition is referred to as gain scheduling. Specifically, the gain scheduling is an approach to control of nonlinear systems using a family of linear controllers, each of which satisfies the design criteria at a certain operating point. Gain-scheduled control is typically implemented using a controller whose gains are automatically tuned as a function of scheduling variables that describe the current operating point. Such variables can include flight time, external operating conditions, system states (throttle level) or environmental parameters (temperature), etc. Gain-scheduled control systems are often designed by choosing a small set of operating points, also known as the design points, and designing a suitable controller for each point. Then, the system switches or interpolates between these controllers according to the current values of the scheduling variables. Nowadays, for FO working at low altitudes (below one kilometer), low velocities (subsonic or near-supersonic) and limited variation in speed, FO's velocity is used as scheduling variable to interpolate control gains. By selecting two velocity points within the flight speed range, denoted as V₁ and V₂ (with V₁<V₂) and using linear interpolation, the control gains are calculated simply. Problems arise when applied to FOs with high velocity, continuously changing over a wide range, high maneuverability (requiring large overloads) and performing flight trajectories at various altitudes, leading to:
Large miss distance error and reduced the probability of hitting the target. These issues occur because the control quality does not meet the design criteria at points far from the two selected operating points. Linear interpolation by velocity at one altitude and required overload does not ensure correctness at other altitudes and overloads.
Increasing the number of operating points significantly increases controller design time and causes many difficulties in selecting controllers at the operating points. On average, computing a controller at one operating point takes about ten continuous working hours. Increasing the number of design points leads to exponential growth in design time. In addition, selecting controllers at operating points for applying linear interpolation algorithms based on velocity is difficult due to the lack of a scientific basis. At each operating point, there are hundreds of controllers satisfying design criteria, and it is required to select controllers that ensure the coefficient curve is smooth and not abruptly changing. Currently, selecting controllers at operating points is still manual, entirely dependent on the designer's experience, which leads to lengthy selection and testing time.

A novel design method for autopilot control system of FOs is developed that adapts to velocity, altitude, and overload fully meets the above requirements, including:
Adaptive control gain sets for varying flight conditions, including velocity, altitude, overload, enable FOs to respond effectively to continuous changes, thereby reducing target miss distance error.
Control gain sets effectively meet design requirements at a wide range of design points and intermediate points between design points, thus improving controller quality and contributing to increasing the probability of target destruction.
Optimizing controller design time, minimizing designer workload and difficulties, and reducing computational burden for the computer.

The proposed method is applicable to all FOs operating in various flight conditions.

### TECHNICAL NATURE OF INVENTION

The purpose of the invention is to design an autopilot control system for unmanned aerial vehicles (UAVs) and high-tech weapons (HTWs) that operate at high speeds, require rapid maneuverability, and function under continuously changing flight conditions. The method proposed in the invention consists of two separate processing parts: determining the initial control gain set and determining the adaptive controller based on velocity, altitude, and required overload. The shared data for both processing parts include:
A dataset describing the aerodynamics of the FO containing aerodynamic coefficient tables over the entire operational domain. These tables are two-dimensional or three-dimensional lookup tables, with the first dimension being flight velocity, the second being angle of attack, and the third being control surface deflection angle.
A file containing information describing the physical parameters of the FO such as diameter (d), reference area (S), moments of inertia (Iₓ, I_{y}, I_{z}), and mass (m).

Specifically, the methodology for designing the FO's autopilot controller includes two consecutive separate processing parts as follows:

Part I: determination of the initial point; this part is critical, as a proper initial value helps the algorithm find the optimal solution that meets the design criteria. The steps are described in detail as follows:

Step 1: determine the initial point. An initial point is characterized by three parameters, including velocity, altitude, and required overload.

Step 2: determine the equilibrium condition at the initial point. The equilibrium condition is determined by the angle of attack, sideslip angle, and control surface deflection at the selected velocity.

Step 3: determine the aerodynamic coefficients at the initial point. These coefficients describe the FO's aerodynamics at the initial point and the equilibrium condition determined in step 2. From the input dataset containing aerodynamic coefficient tables over the entire operational range of the FO, the coefficients at the initial point are retrieved according to angle of attack and control surface deflection at the selected velocity.

Step 4: linearize the FO model at the initial point.

Step 5: define the control criteria, including crossover frequency ω_{CR}; damping ratio ζ; response time τ; overshoot PO, gain margin GM; phase margin PM; system time delay margin T_{delay}.

Step 6: compute the controller gains at the initial point. The controller includes four key coefficients q=[K_{DC}, K_{A}, K_{I}, K_{R}].

Step 7: select the controller at the initial point according to the criteria established in step 5.

Part II: determine of the adaptive controller based on velocity, altitude, and required overload. This part is performed after determining the initial controller in part I. The steps are as follows:

Step 1: select a set of design points across the entire operating domain of the FO. These points are typically chosen at equal interval, forming a grid where each node represents a design point.

Step 2: linearize the FO at each design point.

Step 3: create an interface between the FO and the controller. The controller gains and the FO are represented through an interface through which the gains are adjusted using an optimization algorithm based on the predefined criteria.

Step 4: model the adaptive variables as a parametric gain surface. The adaptive variables are modeled as a gain surface using an adaptive function. According to the method described in the invention, the adaptive function is selected as a function of three adaptive variables in the following form:

$$K ( V , n , h ) = {K}_{0} + {K}_{1} * V + {K}_{2} * n + {K}_{3} * h + {K}_{4} * V * n + {K}_{5} * V * h + …$$

### Where:

V is flight velocity, n is required overload, h is flight altitude.
K₀ denotes the initial controller gain calculated from part I.
Kᵢ(i=1̅,̅2̅,̅ .̅ .̅ .̅ ) are the gains to be computed and tuned.

Step 5: define control criteria for all design points. These criteria can be retained from step 5 of part I or customized depending on the controller's performance at the design point set. However, in part II, control criteria are divided into two types: hard criteria and soft criteria. Hard criteria must be satisfied at all design points, while soft criteria can be adjusted to achieve the highest possible fulfillment across all points.

Step 6: tune the controller gains. The control gains are tuned using an optimization algorithm based on the defined control criteria. The result is a set of four parametric surfaces for the main control gains K_{DC}, K_{A}, K_{I}, K_{R}.

Step 7: evaluate control performance. The adaptive controller gain set using the gain scheduling algorithm must be thoroughly evaluated before practical implementation, through the following procedures:
Check the gain surfaces to ensure there are no singularities or discontinuities.
Visualize the design objectives at all design points before and after adjustment.
Evaluate control performance between design points by adding intermediate points. If performance is not maintained, these points can be added to the design point set and the controller gains retuned.
Verify the control effectiveness on a nonlinear simulation model by constructing benchmark test scenarios and conducting Monte Carlo simulations to evaluate the controller's robustness.

If any of the four procedures above fail, one may reconsider the selection of adaptive variables, the adaptive function, and the design point set.

### BRIEF DESCRIPTION OF DRAWINGS

FIG. 1 is an illustration of the body frame;

FIG. 2 illustrates the local north, east, down (NED) coordinates;

FIG. 3 is a diagram of the three-loop autopilot controller;

FIG. 4 is a diagram illustrating steps for calculating the controller at the initial point;

FIG. 5 is a diagram illustrating steps for designing the adaptive controller across velocity, altitude and required overload;

FIG. 6 is a diagram of the control gain adjustment for the flying objects;

### DETAILED DESCRIPTION OF INVENTION

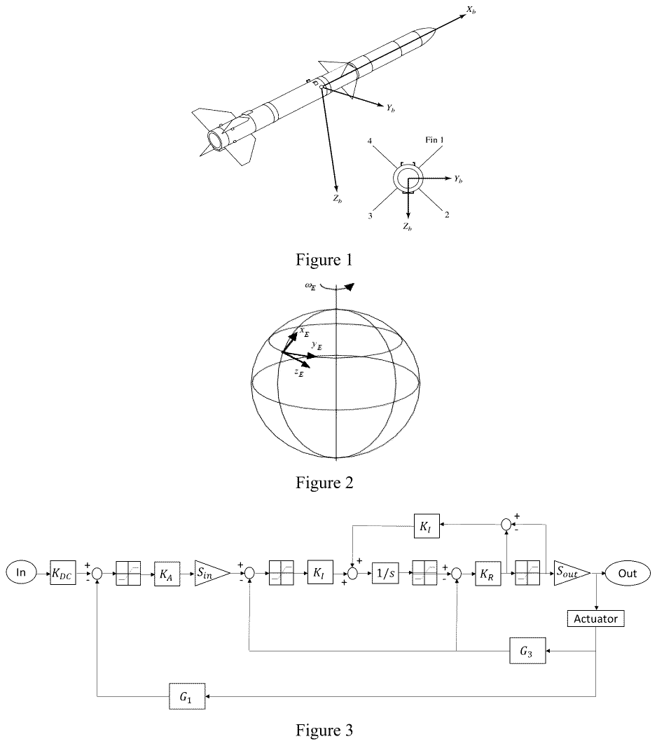

The autopilot loop is a system used in flying objects (FOs) to compute and generate control signals that guide the FO to achieve its flight objectives. Two coordinate systems are employed to reference the angular velocity, acceleration, and state of the FO: the body-fixed coordinate system, denoted as O_{b}X_{b}Y_{b}Z_{b}, and the inertial coordinate system, denoted as O_{E}X_{E}Y_{E}Z_{E}. Referencing FIG. 1, the body-fixed coordinate system has its origin O_{b} at the FO's center of gravity; the O_{b}X_{b} axis aligns with the FO's longitudinal axis, pointing from tail to nose; the O_{b}Z_{b} axis points downward through the FO's belly; and the O_{b}Y_{b} axis completes the right-handed coordinate system with the other two axes. Referencing FIG. 2, the inertial coordinate system has its origin O_{E} at the FO's initial position (before takeoff); the O_{E}X_{E} axis is tangent to the meridian at O_{E}, with the positive direction pointing toward the Earth's North Pole; the O_{E}Y_{E} axis is tangent to the parallel at O_{E}, with the positive direction pointing eastward along the Earth's rotation; and the O_{E}Z_{E} axis completes the right-handed coordinate system with the other two axes. The FO is divided into three control channels as follows:
Roll channel: controls the FO's roll angle around the O_{b}X_{b} axis.
Pitch channel: controls the FO's lift (acceleration) in the O_{E}X_{E}Z_{E} plane.
Yaw channel: controls the FO's lateral thrust (acceleration) in the O_{E}X_{E}Y_{E} plane.

All three channels utilize the control structure illustrated in FIG. 3. Referencing FIG. 3, the FO's control structure comprises three loops: two inner loops for controlling angular velocity errors and one outer loop for controlling the error between the desired signal and the feedback signal. The controller consists of four main gains q=[K_{DC}, K_{A}, K_{I}, K_{R}]. The use of a proportional-integral (PI) inner loop, as shown in FIG. 3, eliminates the zero of the transfer function, resulting in a controller that only contains the integral component of the signal error and the proportional component of the feedback error. An integral saturation block is used to prevent continuous integration. Saturation blocks are added to ensure operational conditions and limits for the control loops, ensuring the algorithm responds appropriately within permissible operating conditions. The advantage of using a common control structure for all three channels is that it simplifies the design and tuning of control gains across all channels, thereby generalizing the control problem. Although a common control structure is used, the objectives and control signals of the three channels differ.
Roll channel: uses an outer loop to control the FO's roll angle to follow the desired value, then calculates the required roll angular velocity for the inner loops to track.
Pitch channel: uses an outer loop to control the acceleration in the O_{E}X_{E}Z_{E} plane to follow the desired value, then calculates the required pitch angular velocity for the inner loops to track.
Yaw channel: uses an outer loop to control the acceleration in the O_{E}X_{E}Y_{E} plane to follow the desired value, then calculates the required yaw angular velocity for the inner loops to track.

Specifically, the method for designing the FO's autopilot controller comprises two sequential processing parts as follows:

Part I: determine the initial controller. Before designing the adaptive controller across a wide range of flight conditions, the controller at an initial point must be calculated. The initial control coefficient set plays a crucial role and must be appropriately selected so that the adaptive control algorithm can find the optimal solution, ensuring control quality at all design points. Therefore, the initial controller must meet all the predefined control criteria.

Furthermore, to design the control coefficients at a flight point, the following steps must be followed:

Step 1: determine the initial point. The initial point is recommended to be at the center of the set of flight conditions. According to the invention's approach, three adaptive variables are selected as V (velocity), h (altitude), n (required load factor). These three variables vary within known value ranges [V₁, V₂]; [h₁, h₂]; [n₁, n₂]. Thus, the initial point is recommended to be K₀ (V₀, h₀, n₀) with:

$${V}_{0} = \frac{{V}_{1} + {V}_{2}}{2} ;$$

$${h}_{0} = \frac{{h}_{1} + {h}_{2}}{2}$$

$${n}_{0} = \frac{{n}_{1} + {n}_{2}}{2}$$

Step 2: determine the equilibrium condition at the initial point. The FO is in a steady equilibrium when the sum of forces and moments acting on it is zero. Solving the pitch channel's total moment equation set to zero yields the angle of attack and control surface deflection angle under equilibrium conditions.

Step 3: determine the aerodynamic coefficients at the initial point. From the input dataset describing the FO's aerodynamics across the entire operating domain, the aerodynamic coefficients at the initial point are determined by table lookup under the equilibrium conditions established in step 2. The aerodynamic coefficients for the three channels are as follows:
Roll channel: Cₗ_{_{δ}}, Cₗ_{ₚ}.
Pitch channel: Cₘ_{_{α}}, C_{z}_{_{δ}}, Cₘ_{_{δ}}, C_{z}_{_{α}}, C_{q}, Cₘ_{_{\acute{α}}}.
Yaw channel: Cₙ_{_{β}}, C_{y}_{_{δ}}, C_{y}_{_{β}}, Cₙ_{_{δ}}, Cₙ_{ᵣ}.

Step 4: linearize the FO at the initial point. From the six-degree-of-freedom equations describing the FO's motion, apply the assumptions: the FO is a rigid body, non-deformable, with constant mass, symmetric about the O_{b}X_{b}Z_{b} plane; the FO's changes are small compared to the equilibrium state; the Earth is an inertial frame; the airflow is steady (no sudden environmental changes); the FO is represented by transfer functions with inputs as control surface deflection angles.
Roll channel: the characteristic transfer functions are the roll angle transfer function, denoted φ/δ, and the roll angular velocity transfer function, denoted as p/δ;

$${G}_{3 x} = \frac{p}{δ} = \frac{{K}_{x}}{{τ}_{r} s + 1}$$

$${G}_{1 x} = \frac{ϕ}{δ} = \frac{{K}_{x}}{s ( {τ}_{r} s + 1 )}$$

where s is the Laplace operator.

$${K}_{x} = - \frac{2 {V}_{0} {C}_{{l}_{δ}}}{d {C}_{{l}_{p}}} ;$$

$${τ}_{r} = - \frac{{I}_{x}}{Q S d} \cdot \frac{2 {V}_{0}}{d {C}_{{l}_{p}}} ;$$

$${S}_{o u {t}_{x}} = 1 ;$$

$${S}_{i {n}_{x}} = sign ( {K}_{x} ) ;$$

Q is the dynamic pressure determined by the formula

$$Q = \frac{1}{2} ρ {V}_{0}^{2} ;$$

ρ is the static pressure, obtained from a lookup table at altitude h₀.
Pitch channel: the characteristic transfer functions are the pitch angular velocity transfer function, denoted q/δ, and the acceleration transfer function in the O_{E}X_{E}Z_{E} plane, denoted as a_{z}/δ;

$${G}_{3 z} = \frac{q}{δ} = \frac{{K}_{3 z} ( 1 + {T}_{3 z} s )}{{( \frac{s}{{ω}_{A {F}_{z}}} )}^{2} + \frac{2 {ζ}_{A {F}_{z}}}{{ω}_{A {F}_{z}}} s + 1}$$

$${G}_{1 z} = \frac{{a}_{z}}{δ} = \frac{{K}_{1 z} ( 1 + \frac{{S}_{z}}{{ω}_{zz}^{2}} {s}^{2} )}{{( \frac{1}{{ω}_{A {F}_{z}}} )}^{2} {s}^{2} + 2 \frac{{ζ}_{A {F}_{z}}}{{ω}_{A {F}_{z}}} \cdot s + 1}$$

The coefficients in the two transfer functions are determined as follows:

$${K}_{3 z} = 2 ρ S {V}_{0} \frac{{C}_{{m}_{α}} {C}_{{z}_{δ}} - {C}_{{m}_{δ}} {C}_{{z}_{α}}}{S ρ d {C}_{{z}_{α}} {C}_{{m}_{q}} - 4 m {C}_{{m}_{α}}}$$

$${T}_{3 z} = \frac{1}{2 ρ {SV}_{0}} \frac{S ρ {dC}_{{z}_{δ}} {C}_{{m}_{\dot{α}}} + 4 m {C}_{{m}_{δ}}}{{C}_{{z}_{δ}} {C}_{{m}_{α}} - {C}_{{m}_{δ}} {C}_{{z}_{α}}}$$

$${ω}_{A {F}_{z}} = \frac{{V}_{0} ρ S d}{2 \sqrt{{I}_{y} m}} \sqrt{\frac{1}{2} {C}_{{z}_{α}} {C}_{m q} - \frac{2 m}{ρ S d} {C}_{{m}_{α}}}$$

$${ζ}_{{AF}_{z}} = - \frac{d \sqrt{\frac{m}{{I}_{y}}}}{4} \cdot \frac{{C}_{{m}_{q}} {C}_{{m}_{\dot{α}}} + \frac{2 I}{{md}^{2}} {C}_{{z}_{α}}}{\sqrt{\frac{1}{2} {C}_{{z}_{α}} {C}_{{m}_{q}} - \frac{2 m}{ρ Sd} {C}_{{m}_{α}}}}$$

$${K}_{1 z} = - 2 ρ {SV}_{0}^{2} \frac{{C}_{{m}_{α}} {C}_{{z}_{δ}} - {C}_{{z}_{α}} {C}_{{m}_{δ}}}{S ρ d {C}_{{z}_{α}} {C}_{{m}_{q}} - 4 m {C}_{{m}_{α}}}$$

$${S}_{z} = sign ( \frac{{C}_{{m}_{α}} {C}_{{z}_{δ}} - {C}_{{z}_{α}} {C}_{{m}_{δ}}}{{C}_{{z}_{δ}}} )$$

$${ω}_{zz} = {V}_{0} \sqrt{\frac{S ρ d}{2 {I}_{y}}} \sqrt{{S}_{z} \frac{{C}_{{m}_{α}} {C}_{{z}_{δ}} - {C}_{{z}_{α}} {C}_{{m}_{δ}}}{{C}_{{z}_{δ}}}}$$

$${S}_{o u {t}_{z}} = sign ( {K}_{3 z} {K}_{1 z} ) ;$$

$${S}_{i {n}_{z}} = sign ( {K}_{1 z} {S}_{o u {t}_{z}} ) ;$$

Yaw channel: the characteristic transfer functions are the yaw angular velocity transfer function, denoted r/δ, and the acceleration transfer function in the O_{E}X_{E}Y_{E} plane, denoted a_{y}/δ;

$${G}_{3 y} = \frac{r}{δ} = \frac{{K}_{3 y} ( 1 + {T}_{3 y} s )}{{( \frac{s}{{ω}_{A {F}_{y}}} )}^{2} + \frac{2 {ζ}_{{AF}_{y}}}{{ω}_{A {F}_{y}}} s + 1}$$

$${G}_{1 y} = \frac{{a}_{y}}{δ} = \frac{{K}_{1 y} ( 1 + \frac{{S}_{y}}{{ω}_{yy}^{2}} {s}^{2} )}{{( \frac{1}{{ω}_{A {F}_{y}}} )}^{2} {s}^{2} + 2 \frac{{ζ}_{A {F}_{y}}}{{ω}_{A {F}_{y}}} \cdot s + 1}$$

The coefficients in the two transfer functions are determined as follows:

$${K}_{3 y} = 2 ρ S {V}_{0} \frac{{C}_{{n}_{β}} {C}_{{y}_{δ}} - {C}_{{n}_{δ}} {C}_{{y}_{β}}}{S ρ d {C}_{{y}_{β}} {C}_{{n}_{r}} - 4 m {C}_{{n}_{β}}}$$

$${T}_{3 y} = \frac{2 m}{2 ρ {SV}_{0}} \frac{{C}_{{n}_{δ}}}{{C}_{{y}_{δ}} {C}_{{n}_{β}} - {C}_{{n}_{δ}} {C}_{{y}_{β}}}$$

$${ω}_{A {F}_{y}} = \frac{{V}_{0} \sqrt{S ρ d}}{\sqrt{8 {I}_{z} m}} \sqrt{S ρ {dC}_{{n}_{r}} {C}_{{y}_{β}} + 4 m {C}_{{n}_{β}}}$$

$${ζ}_{{AF}_{y}} = - \frac{( 2 {I}_{z} {C}_{{y}_{β}} + {md}^{2} {C}_{{n}_{r}} ) \sqrt{S ρ}}{\sqrt{8 {dI}_{z} m} \sqrt{S ρ {dC}_{{n}_{r}} {Cy}_{β} + 4 {mC}_{{n}_{β}}}}$$

$${K}_{1 y} = 2 ρ {SV}_{0}^{2} \frac{{C}_{{n}_{β}} {C}_{{y}_{δ}} - {C}_{{y}_{β}} {C}_{{n}_{δ}}}{S ρ d {C}_{{y}_{β}} {C}_{{n}_{r}} - 4 m {C}_{{n}_{β}}}$$

$${S}_{y} = sign ( \frac{{C}_{{y}_{β}} {C}_{{n}_{δ}} - {C}_{{n}_{β}} {C}_{{y}_{δ}}}{{C}_{{y}_{δ}}} )$$

$${ω}_{yy} = {V}_{0} \sqrt{\frac{S ρ d}{2 {I}_{z}}} \sqrt{{S}_{y} \frac{{C}_{{y}_{β}} {C}_{{n}_{δ}} - {C}_{{n}_{β}} {C}_{{y}_{δ}}}{{C}_{{y}_{δ}}}}$$

$${S}_{{out}_{y}} = sign ( {K}_{3 y} {K}_{1 y} ) ;$$

$${S}_{i {n}_{y}} = sign ( {K}_{1 y} {S}_{o u {t}_{y}} ) ;$$

Step 5: define control criteria. Three positive control design parameters are used to calculate the controller, including open-loop crossover frequency ω_{CR}; damping ratio ζ, and time response τ. The value of ω_{CR} is less than one-third of the bandwidth of the actuator used on the FO. The damping ratio ζ ranges from zero to one. The higher the damping ratio, the faster the oscillation decays; however, this may result in greater overshoot and increased oscillation frequency. Conversely, the larger the response time τ, the slower the system response. Additionally, other criteria must be defined to select the controller, including: overshoot (PO), gain margin (GM), phase margin (PM), and time delay margin T_{delay}. These criteria depend on each type of FO, system characteristics, and may be adjusted after evaluation tests. Control criteria for each channel are denoted as follows:
Roll channel: ω_{CR}_{ₓ}, ζₓ, τₓ, POₓ, GMₓ, PMₓ, T_{delay}_{ₓ}
Pitch channel: ω_{CR}_{_{z}}, ζ_{z}, τ_{z}, PO_{z}, GM_{z}, PM_{z}, T_{delay}_{_{z}}
Yaw channel: ω_{CR}_{_{y}}, ζ_{y}, τ_{y}, PO_{y}, GM_{y}, PM_{y}, T_{delay}_{_{y}}

Step 6: calculate the controllers at the initial point. The control coefficients are calculate using the following formulas:

### Roll Channel:

$${K}_{D {C}_{x}} = 1 ;$$

$${K}_{{A}_{x}} = \frac{{ω}_{x}}{2 {ζ}_{x} + {τ}_{x} {ω}_{x}} ;$$

$${K}_{{I}_{x}} = \frac{{ω}_{x}^{2}}{{K}_{{A}_{x}} {ω}_{C {R}_{x}} {τ}_{x}} ;$$

$${K}_{{R}_{x}} = \frac{{ω}_{C {R}_{x}} {τ}_{r}}{{K}_{x}} ;$$

### Where:

$${ω}_{x} = \frac{{τ}_{x} {ω}_{C {R}_{x}} ( 1 + \frac{1}{{τ}_{r} {ω}_{C {R}_{x}}} ) - 1}{2 {ζ}_{x} {τ}_{x}} ;$$

### Pitch Channel:

$${K}_{D {C}_{z}} = 1 + {K}_{c z} ;$$

$${K}_{{A}_{z}} = - \frac{{K}_{3 z}}{{K}_{C z} {K}_{1 z}} ;$$

$${K}_{{I}_{z}} = \frac{{K}_{Cz} {T}_{3 z} {ω}_{0 z}^{2}}{1 + {K}_{{C}_{z}} + \frac{{ω}_{0 z}^{2}}{{ω}_{zz}^{2}}} ;$$

$${K}_{{R}_{z}} = - \frac{{K}_{0 z}}{{K}_{{A}_{z}} {K}_{{I}_{z}} {K}_{1 z} ( 1 + {K}_{C z} )} ;$$

Intermediate parameters are computed as:

$${ω}_{z} = \frac{{ω}_{C {R}_{z}} {τ}_{z} ( 1 + \frac{2 {ω}_{A {F}_{z}} {ζ}_{A {F}_{z}}}{{ω}_{C {R}_{z}}} ) - 1}{2 {ζ}_{z} {τ}_{z}} ;$$

$${ω}_{0 z} = \frac{{ω}_{z}}{\sqrt{{ω}_{C {R}_{z}} {τ}_{z}}} ;$$

$${ζ}_{0 z} = \frac{1}{2} {ω}_{0 z} ( 2 \frac{{ζ}_{z}}{{ω}_{z}} + {τ}_{z} - \frac{{ω}_{A {F}_{z}^{2}}}{{ω}_{C {R}_{z}} {ω}_{0 z}^{2}} ) ;$$

$${K}_{0 z} = - \frac{{ω}_{z}^{2}}{{τ}_{z} {ω}_{A {F}_{z}}^{2}} ;$$

$${K}_{Cz} = \frac{2 {ζ}_{0 z} {ω}_{0 z} {T}_{3 z} - \frac{{ω}_{0 z}^{2}}{{ω}_{zz}^{2}} - 1}{1 - 2 {ζ}_{0 z} {ω}_{0 z} {T}_{3 z} + {T}_{3 z}^{2} {ω}_{0 z}^{2}} ;$$

### Yaw Channel:

$${K}_{D {C}_{y}} = 1 + {K}_{Cy} ;$$

$${K}_{{A}_{y}} = \frac{{K}_{3 y}}{{K}_{Cy} {K}_{1 y}} ;$$

$${K}_{{I}_{y}} = \frac{{K}_{Cy} {T}_{3 y} {ω}_{0 y}^{2}}{1 + {K}_{{C}_{y}} + \frac{{ω}_{0 y}^{2}}{{ω}_{yy}^{2}}} ;$$

$${K}_{{R}_{y}} = \frac{{K}_{0 y}}{{K}_{{A}_{y}} {K}_{{I}_{y}} {K}_{1 y} ( 1 + {K}_{Cy} )} ;$$

Initial parameters are derived as:

$${ω}_{y} = \frac{{ω}_{C {R}_{y}} {τ}_{y} ( 1 + \frac{2 {ω}_{A {F}_{y}} {ζ}_{A {F}_{y}}}{{ω}_{C {R}_{y}}} ) - 1}{2 {ζ}_{y} {τ}_{y}} ;$$

$${ω}_{0 y} = \frac{{ω}_{y}}{\sqrt{{ω}_{C {R}_{y}} {τ}_{y}}} ;$$

$${ζ}_{0 y} = \frac{1}{2} {ω}_{0 y} ( 2 \frac{{ζ}_{y}}{{ω}_{y}} + {τ}_{y} - \frac{{ω}_{A {F}_{y}^{2}}}{{ω}_{C {R}_{y}} {ω}_{0 y}^{2}} ) ;$$

$${K}_{0 y} = - \frac{{ω}_{y}^{2}}{{τ}_{y} {ω}_{{AF}_{y}}^{2}} ;$$

$${K}_{Cy} = \frac{2 {ζ}_{0 y} {ω}_{0 y} {T}_{3 y} - \frac{{ω}_{0 y}^{2}}{{ω}_{yy}^{2}} - 1}{1 - 2 {ζ}_{0 y} {ω}_{0 y} {T}_{3 y} + {T}_{3 y}^{2} {ω}_{0 y}^{2}} ;$$

Step 7: select the controller at the initial point based on the criteria defined in step 5. At the end of step 7, the controller at the initialization point is obtained as:

$${q}_{0} = [ {K}_{{DC}_{o}} , {K}_{{A}_{o}} , {K}_{{I}_{o}} , {K}_{{R}_{o}} ]$$

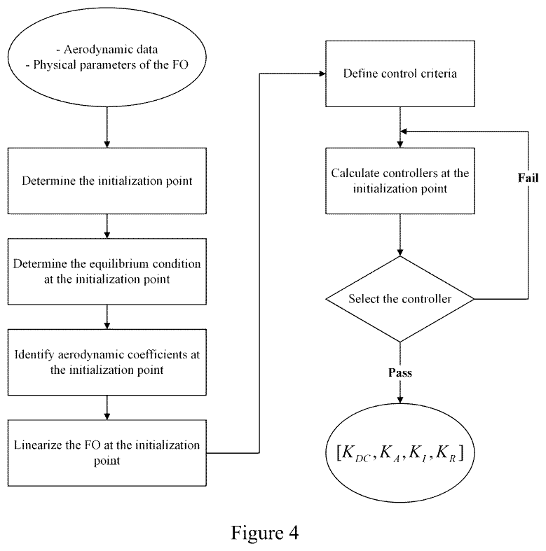

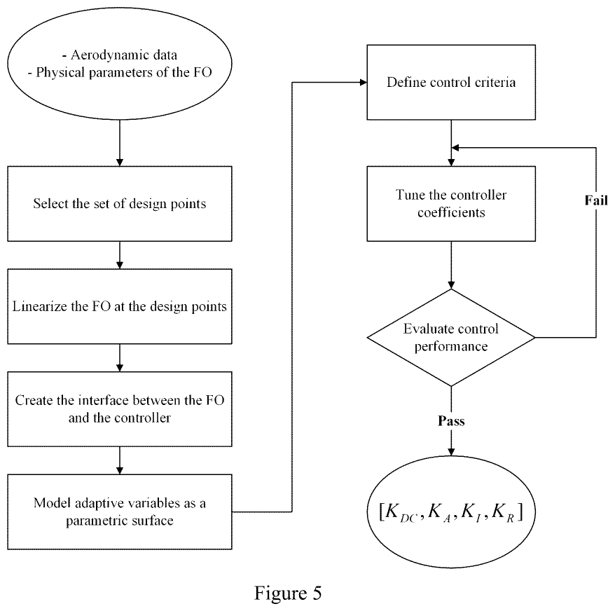

The flowchart of the calculation steps for the initial controller is shown in FIG. 4.

Part II: determine the adaptive controller based on velocity, altitude, and required overload; this part is implemented in MATLAB after the initial controller is determined in part I. The steps are as follows:

Step 1: select a set of design points across the entire operational domain of the FO. Select j₁ velocity points in the range [V₁, V₂], denoted Vₐᵣᵣ; select j₂ altitude points in [h₁, h₂], denoted harr; select j₃ overload points in [n₁, n₂], denoted nₐᵣᵣ Use the ndgrid command to generate a 3D grid of design points:

$$[ V , h , n ] = ndgrid ( {V}_{arr} , {h}_{arr} , n\_arr )$$

Use the struct command to create the grid of design points:

$$TuningGrid = s truct {(}^{′} {V}^{′} , V {,}^{′} {h}^{′} , h {,}^{′} {n}^{′} , n )$$

Step 2: linearize the FO at the design points. Perform the same as step 4 in part I for all design points to obtain an array of linear models, denoted G.

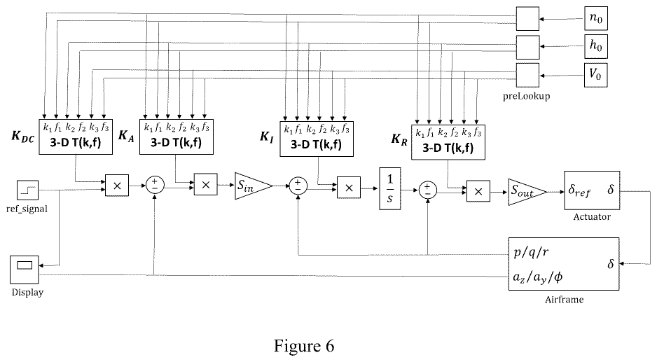

Step 3: create an interface between the FO and the controller. Use the slTuner command to replace the FO with the array of linear models. The slTuner interface connects to the control coefficients and forms a closed-loop model for each design point. Referencing FIG. 6, the name of the model used to be tune the FO controller gains is AP. First, create the structure using the struct command:

$$BlockSubs = struct {(}^{′} {Name}^{′} {,}^{′} AP / M \hat{o} h nh {TBB}^{′} {,}^{′} {Value}^{′} , G )$$

$$ST 0 = slTuner ( AP , {\{}^{′} {K}_{DC}^{′} {,}^{′} {K}_{DC}^{′} {,}^{′} {K}_{I}^{′} {,}^{′} {K}_{R}^{′} \} , BlockSubs )$$

Step 4: model the adaptive variables as a parametric surface. According to the method in the invention, the adaptive function is a three-variable function of the form:

$$K ( V , n , h ) = {K}_{0} + {K}_{1} * V + {K}_{2} * n + {K}_{3} * h + {K}_{4} * V * n + {K}_{5} * V * h …$$

### Where:

V is the flight velocity, n is the required overload, h is the flight altitude.
K₀ is the initial control coefficient from Part I.
Kᵢ(i=1̅,̅2̅,̅ .̅ .̅ .̅ ) are coefficients to be computed and tuned.

The parametric surface is written as:

$$shapeFcn = @ ( V , h , n ) [ V , h , n , V * n , V * h ]$$

Then, use the tunableSurface command to create the parametric gain surfaces:

$${K}_{DC} = tunableSurface ( {}^{′} {{K}_{DC}^{′}}_{} , {K}_{{DC}_{0}} , TuningGrid , ShapeFcn )$$

$${K}_{A} = tunableSurface ( {}^{′} {{K}_{A}^{′}}_{} , {K}_{{A}_{0}} , TuningGrid , ShapeFcn )$$

$${K}_{I} = tunableSurface ( {}^{′} {{K}_{I}^{′}}_{} , {K}_{{I}_{0}} , TuningGrid , ShapeFcn )$$

$${K}_{R} = tunableSurface ( {}^{′} {{K}_{R}^{′}}_{} , {K}_{{R}_{0}} , TuningGrid , ShapeFcn )$$

Set the control parameter values using the setBlockParam command:

$$ST 0. setBlockParam ( {}^{′} {{K}_{DC}^{′}}_{} , {K}_{DC} , {}^{′} {K}_{A}^{′} , {K}_{A}^{′} , {}^{′} {K}_{I}^{′} , {K}_{I}^{′} , {}^{′} {K}_{R}^{′} , {K}_{R} )$$

Step 5: define the control criteria for all design points. These criteria can be retained from step 5 of part I or adjusted depending on the controller's performance across the design set. However, in part II, control criteria are categorized as hard and soft constraints. Hard constraints must be satisfied at all design points, while soft constraints can be adjusted to achieve the highest fulfillment across the points. All design points may share the same criteria or be defined individually. Use the TuningGoal to establish the control goals, for example: Req1=TuningGoal. Poles(0,0.1) sets a minimum damping ratio of 0,1. Req2=TuningGoal. Margins(‘delta’, 6,45) sets gain and phase margins to 6 dB and 45° for all design points.

Step 6: adjust the control coefficients. Use the systune command to optimize the control coefficients based on the defined control goals. The result is a set of parametric surfaces for the main control gains K_{DC}, K_{A}, K_{I}, K_{R}:

$$ST = systune ( ST 0 , Req 1 , Req 2 )$$

where Req1 is the soft constraint (defined first), Req2 is the hard constraint (defined later).

Step 7: evaluate control quality. The adaptive controller gain set must be thoroughly evaluated for the following reasons. First, gain tuning only guarantees control performance at the design points. Second, the method ignores dynamic cross-coupling effects among the three control channels. Third, the linearization omits the FO's nonlinear behavior, so it does not fully represent the FO under all operating conditions. Evaluation of control quality includes:
Check the control gain surfaces to ensure there are no singularities or sharp discontinuities. Use the getBlockParam command to decode the tuned gain data:

$$TGS = getBlockParam ( ST )$$

Plot the gain surfaces using viewSurf:

```
viewSurf (TGS. K_{DC})
  viewSurf (TGS. K_{A})
  viewSurf (TGS. K_{I})
  viewSurf (TGS. K_{R})
```

From the plots, verify that the surfaces are smooth, continuous, and free of irregularities.
Visualize the design goals at all design points before and after tuning. Use the viewGoal command to check the system response before and after tuning. For example, to verify criterion 1: viewGoal(Req1,ST0) plots the system response before tuning; viewGoad(Req1,ST) plots the system response after tuning. Compare the two plots to evaluate the difference.
Evaluate control performance between design points by adding intermediate points. If performance is not satisfactory, include these points into the design set and retune the control coefficients. This process requires FO control performance evaluation software.
Assess controller performance on a nonlinear simulation model by creating test scenarios representing ideal cases and performing Monte Carlo simulations to evaluate robustness. This step requires FO motion simulation software.

If any of the four stages above are not met, consider revising the selection of adaptive variables, the adaptive function form, and the design point set.

The flowchart of the adaptive control gain determination process is presented in FIG. 5.

### Effect of Invention

The autopilot controller determination method described in this invention has achieved the following outcomes:
Reduced target miss distance error and increased target kill probability, as the FO controller effectively adapts to a wide range of flight contexts, thereby improving control performance.
Optimized the design time for the autopilot controller.
Reduced workload and complexity for the designer, thereby enhancing productivity.
Superior control quality compared to other methods.

1. A method for designing an autopilot controller for a flying object (FO) that adapts to velocity, altitude, and required load factor is carried out through the following parts:
part I: determine a initial controller; in this part:
step 1: determine an initial point; the initial point is recommended to lie at a center of the range of flight conditions; three adaptive variables are selected V (velocity), h (altitude), n (required load factor); these three variables vary within known ranges [V₁, V₂]; [h₁, h₂]; [n₁, n₂]; therefore, a recommended initial point is K₀(V₀, h₀, n₀) when:
$${V}_{0} = \frac{{V}_{1} + {V}_{2}}{2} ;$$
$${h}_{0} = \frac{{h}_{1} + {h}_{2}}{2}$$
$${n}_{0} = \frac{{n}_{1} + {n}_{2}}{2}$$
step 2: determine an equilibrium condition at the initial point; the FO is in steady equilibrium when total forces and moments acting on it are zero; by solving a pitch channel's moment balance equation set to zero, an angle of attack and a control surface deflection angle under equilibrium can be found;
step 3: determine aerodynamic coefficients at the initial point; from an input dataset describing the aerodynamics across a full operating domain of the FO, the aerodynamic coefficients at the initial point are obtained via lookup under equilibrium conditions identified in step 2; the aerodynamic coefficients are categorized by channel as follows:
roll channel: Cₗ_{_{δ}}, Cₗ_{ₚ};
pitch channel: Cₘ_{_{α}}, C_{z}_{_{δ}}, Cₘ_{_{δ}}, C_{z}_{_{α}}, Cₘ_{_{q}}, Cₘ_{_{\acute{α}}};
yaw channel: Cₙ_{_{β}}, C_{y}_{_{δ}}, C_{y}_{_{β}}, Cₙ_{_{δ}}, Cₙ_{ᵣ};
step 4: linearize the FO at the initial point; from six-degree-of-freedom equations describing the motion of the FO, apply the following assumptions: the FO is a rigid, non-deformable body with constant mass, and symmetric about the O_{b}X_{b}Z_{b} plane; variations of the FO are small compared to an equilibrium state; the Earth is considered an inertial frame, airflow is steady, the FO is represented by transfer functions with control surface deflection angles as inputs:
roll channel: the characteristic transfer functions are a roll angle transfer function, denoted φ/δ, and a roll angular velocity transfer function, denoted as p/δ with the following expressions:
$${G}_{3 x} = \frac{p}{δ} = \frac{{K}_{x}}{{τ}_{r} s + 1}$$
$${G}_{1 x} = \frac{p}{δ} = \frac{{K}_{x}}{s ( {τ}_{r} s + 1 )}$$
where s is the Laplace operator;
$${K}_{x} = - \frac{2 {V}_{0} {C}_{{l}_{δ}}}{{dC}_{{l}_{p}}} ;$$
$${τ}_{r} = - \frac{{I}_{x}}{QSd} \cdot \frac{2 {V}_{0}}{{dC}_{{l}_{p}}} ;$$
$${S}_{{out}_{x}} = 1 ;$$
$${S}_{{in}_{x}} = sign ( {K}_{x} ) ;$$
Q is a dynamic pressure determined by the formula:
$$Q = \frac{1}{2} ρ {V}_{0}^{2} ;$$
ρ is a static pressure, which is retrieved from a lookup table at altitude h₀;
pitch channel: the characteristic transfer functions include a pitch angular velocity transfer function, denoted as q/δ and the acceleration transfer function in a O_{E}X_{E}Z_{E} plane, denoted as a_{z}/δ;
$${G}_{3 z} = \frac{q}{δ} = \frac{{K}_{3 z} ( 1 + {T}_{3 z} s )}{{( \frac{s}{{ω}_{{AF}_{z}}} )}^{2} + \frac{2 {ζ}_{{AF}_{z}}}{{ω}_{{AF}_{z}}} s + 1}$$
$${G}_{1 z} = \frac{{a}_{z}}{δ} = \frac{{K}_{1 z} ( 1 + \frac{{S}_{z}}{{ω}_{zz}^{2}} {s}^{2} )}{{( \frac{1}{{ω}_{{AF}_{z}}} )}^{2} {s}^{2} + 2 \frac{{ζ}_{{AF}_{z}}}{{ω}_{{AF}_{z}}} \cdot s + 1}$$
the coefficients in these two transfer functions are defined as follows:
$${K}_{3 z} = 2 ρ {SV}_{0} \frac{{C}_{{m}_{α}} {C}_{{z}_{δ}} - {C}_{{m}_{δ}} {C}_{{z}_{α}}}{S ρ {dC}_{{z}_{α}} {C}_{{m}_{q}} + 4 {mC}_{{m}_{α}}}$$
$${T}_{3 z} = \frac{1}{2 ρ {SV}_{0}} \frac{S ρ {dC}_{{z}_{β}} {C}_{{m}_{\dot{α}}} + 4 {mC}_{{m}_{δ}}}{{C}_{{z}_{δ}} {C}_{{m}_{α}} - {C}_{{m}_{δ}} {C}_{{z}_{α}}}$$
$${ω}_{{AF}_{z}} = \frac{{V}_{0} ρ Sd}{2 \sqrt{{I}_{y} m}} \sqrt{\frac{1}{2} {C}_{{z}_{α}} {C}_{mq} - \frac{2 m}{ρ Sd} {C}_{{m}_{α}}}$$
$${ζ}_{{AF}_{z}} = - \frac{d \sqrt{\frac{m}{{I}_{y}}}}{4} \cdot \frac{{C}_{{m}_{q}} {C}_{{m}_{\dot{α}}} + \frac{2 {I}_{y}}{{md}^{2}} {C}_{{z}_{α}}}{\sqrt{\frac{1}{2} {C}_{{z}_{α}} {C}_{{m}_{q}} - \frac{2 m}{ρ Sd} {C}_{{m}_{α}}}}$$
$${K}_{1 z} = - 2 ρ {SV}_{0}^{2} \frac{{C}_{{m}_{α}} {C}_{{z}_{δ}} - {C}_{{z}_{α}} {C}_{{m}_{δ}}}{S ρ {dC}_{{z}_{α}} {C}_{{m}_{q}} - 4 {mC}_{{m}_{α}}}$$
$${S}_{z} = sign ( \frac{{C}_{{m}_{α}} {C}_{{z}_{δ}} - {C}_{{z}_{α}} {C}_{{m}_{δ}}}{{C}_{{z}_{δ}}} )$$
$${ω}_{zz} = {V}_{0} \sqrt{\frac{S ρ d}{2 {I}_{y}}} \sqrt{{S}_{z} \frac{{C}_{{m}_{α}} {C}_{{z}_{δ}} - {C}_{{z}_{α}} {C}_{{m}_{δ}}}{{C}_{{z}_{δ}}}}$$
$${S}_{{out}_{z}} = sign ( {K}_{3 z} {K}_{1 z} ) ;$$
$${S}_{{in}_{z}} = sign ( {K}_{1 z} {S}_{{out}_{z}} ) ;$$
yaw channel: the characteristic transfer functions include a yaw angular velocity transfer function, denoted as r/δ and the acceleration transfer function in the O_{E}X_{E}Y_{E} plane, denoted as a_{y}/δ;
$${G}_{3 y} = \frac{r}{δ} = \frac{{K}_{3 y} ( 1 + {T}_{3 y} s )}{{( \frac{S}{{ω}_{{AF}_{y}}} )}^{2} + \frac{2 {ζ}_{{AF}_{γ}}}{{ω}_{{AF}_{y}}} s + 1}$$
$${G}_{1 y} = \frac{{a}_{y}}{δ} = \frac{{K}_{1 y} ( 1 + \frac{{S}_{y}}{{ω}_{yy}^{2}} {s}^{2} )}{{( \frac{1}{{ω}_{{AF}_{y}}} )}^{2} {s}^{2} + 2 \frac{{ζ}_{{AF}_{y}}}{{ω}_{{AF}_{y}}} \cdot s + 1}$$
the coefficients in these two transfer functions are defined as follows:
$${K}_{3 y} = 2 ρ {SV}_{0} \frac{{C}_{{n}_{β}} {C}_{{y}_{δ}} - {C}_{{n}_{δ}} {C}_{{y}_{β}}}{S ρ {dC}_{{y}_{β}} {C}_{{n}_{r}} + 4 {mC}_{{n}_{β}}}$$
$${T}_{3 y} = \frac{2 m}{ρ {SV}_{0}} \frac{{C}_{{n}_{δ}}}{{C}_{{y}_{δ}} {C}_{{n}_{β}} - {C}_{{n}_{δ}} {C}_{{y}_{β}}}$$
$${ω}_{{AF}_{y}} = \frac{{V}_{0} \sqrt{S ρ d}}{\sqrt{8 {I}_{z} m}} \sqrt{S ρ {dC}_{{n}_{r}} {C}_{{y}_{β}} + 4 {mC}_{{n}_{β}}}$$
$${ζ}_{{AF}_{y}} = - \frac{( 2 {I}_{z} {C}_{{y}_{β}} + {md}^{2} {C}_{{n}_{r}} ) \sqrt{S ρ}}{\sqrt{8 {dI}_{z} m} \sqrt{S ρ {dC}_{{n}_{r}} {C}_{{y}_{β}} + 4 {mC}_{{n}_{β}}}}$$
$${K}_{1 y} = 2 ρ {SV}_{0}^{2} \frac{{C}_{{n}_{β}} {C}_{{y}_{δ}} - {C}_{{y}_{β}} {C}_{{n}_{δ}}}{S ρ {dC}_{{y}_{β}} {C}_{{n}_{r}} + 4 {mC}_{{n}_{β}}}$$
$${S}_{y} = sign ( \frac{{C}_{{y}_{β}} {C}_{{n}_{δ}} - {C}_{{n}_{β}} {C}_{{y}_{δ}}}{{C}_{{y}_{δ}}} )$$
$${ω}_{yy} = {V}_{0} \sqrt{\frac{S ρ d}{2 {I}_{z}}} \sqrt{{S}_{y} \frac{{C}_{{y}_{β}} {C}_{{n}_{δ}} - {C}_{{n}_{β}} {C}_{{y}_{δ}}}{{C}_{{y}_{δ}}}}$$
$${S}_{{out}_{y}} = sign ( {K}_{3 y} {K}_{1 y} ) ;$$
$${S}_{{in}_{y}} = sign ( {K}_{1 y} {S}_{{out}_{y}} ) ;$$
step 5: define a control criteria; three positive parameters used for computing the controller are as follows: an open-loop cutoff frequency, denoted as ω_{CR}; a damping ratio, denoted as ζ a response time, denoted a τ, a value of ω_{CR} is less than one-third of a bandwidth of an actuator used on the FO; a value of ζ ranges from 0 to 1, a higher damping ratio results in faster attenuation of oscillations; however, it may cause a larger overshoot and higher oscillation frequency; conversely, a larger τ leads to a slower system response; additionally, control selection criteria are determined, including: percent overshoot (PO), gain margin (GM), phase margin (PM), time-delay margin T_{delay}; these criteria depend on the type of FO, the characteristics of the system, and can be adjusted after conducting evaluation tests; the control criteria for each control channel are denoted as follows:
roll channel: ω_{CR}_{ₓ}, ζₓ, τₓ, POₓ, GMₓ, PMₓ, T_{delay}_{ₓ}
pitch channel: ω_{CR}_{_{z}}, ζ_{z}, τ_{z}, PO_{z}, GM_{z}, PM_{z}, T_{delay}_{_{z}}
yaw channel: ω_{CR}_{_{y}}, ζ_{y}, τ_{y}, PO_{y}, GM_{y}, PM_{y}, T_{delay}_{_{y}}
step 6: calculate controllers at an initialization point; the controller coefficients are calculated using the following formulas:
roll channel:
$${K}_{{DC}_{x}} = 1 ;$$
$${K}_{{A}_{x}} = \frac{{ω}_{x}}{2 {ζ}_{x} + {τ}_{x} {ω}_{x}} ;$$
$${K}_{{I}_{x}} = \frac{{ω}_{x}^{2}}{{K}_{{A}_{x}} {ω}_{{CR}_{x}} {τ}_{x}} ;$$
$${K}_{{R}_{x}} = \frac{{ω}_{{CR}_{x}} {τ}_{r}}{{K}_{x}} ;$$
where:
$${ω}_{x} = \frac{{τ}_{x} {ω}_{C {R}_{x}} ( 1 + \frac{1}{{τ}_{r} {ω}_{C {R}_{x}}} ) - 1}{2 {ζ}_{x} {τ}_{x}} ;$$
pitch channel:
$${K}_{{DC}_{z}} = 1 + {K}_{c z} ;$$
$${K}_{{A}_{z}} = - \frac{{K}_{3 z}}{{K}_{C z} {K}_{1 z}} ;$$
$${K}_{{I}_{Z}} = - \frac{{K}_{C z} {T}_{3 z} {ω}_{0 z}^{2}}{1 + {K}_{C z} + \frac{{ω}_{0 z}^{2}}{{ω}_{zz}^{2}}} ;$$
$${K}_{{R}_{z}} = - \frac{{K}_{0 z}}{{K}_{{A}_{z}} {K}_{{I}_{z}} {K}_{1 z} ( 1 + {K}_{C z} )} ;$$
the intermediate coefficients are determined sequentially according to the following formulas:
$${ω}_{z} = \frac{{ω}_{C {R}_{z}} {τ}_{z} ( 1 + \frac{2 {ω}_{A {F}_{z}} {ζ}_{A {F}_{z}}}{{ω}_{C {R}_{z}}} ) - 1}{2 {ζ}_{z} {τ}_{z}} ;$$
$${ω}_{0 z} = \frac{{ω}_{z}}{\sqrt{{ω}_{C {R}_{z}} {τ}_{z}}} ;$$
$${ζ}_{0 z} = \frac{1}{2} {ω}_{0 z} ( 2 \frac{{ζ}_{z}}{{ω}_{z}} + {τ}_{z} - \frac{{ω}_{{AF}_{z}}^{2}}{{ω}_{C {R}_{z}} {ω}_{0 z}^{2}} ) ;$$
$${K}_{0 z} = - \frac{{ω}_{z}^{2}}{{τ}_{z} {ω}_{A {F}_{z}}^{2}} ;$$
$${K}_{Cz} = \frac{2 {ζ}_{0 z} {ω}_{0 z} {T}_{3 z} - \frac{{ω}_{0 z}^{2}}{{ω}_{zz}^{2}} - 1}{1 - 2 {ζ}_{0 z} {ω}_{0 z} {T}_{3 z} + {T}_{3 z}^{2} {ω}_{0 z}^{2}} ;$$
yaw channel:
$${K}_{D {C}_{y}} = 1 + {K}_{C y} ;$$
$${K}_{{A}_{y}} = \frac{{K}_{3 y}}{{K}_{C y} {K}_{1 y}} ;$$
$${K}_{{I}_{y}} = \frac{{K}_{Cy} {T}_{3 y} {ω}_{0 y}^{2}}{1 + {K}_{Cy} + \frac{{ω}_{0 y}^{2}}{{ω}_{yy}^{2}}} ;$$
$${K}_{{R}_{y}} = \frac{{K}_{0 y}}{{K}_{{A}_{y}} {K}_{{I}_{y}} {K}_{1 y} ( 1 + {K}_{C y} )} ;$$
the intermediate coefficients are determined sequentially according to the following formulas:
$${ω}_{y} = \frac{{ω}_{{CR}_{y}} {τ}_{y} ( 1 + \frac{2 {ω}_{{AF}_{y}} {ζ}_{{AF}_{y}}}{{ω}_{{CR}_{y}}} ) - 1}{2 {ζ}_{y} {τ}_{y}} ;$$
$${ω}_{0 y} = \frac{{ω}_{y}}{\sqrt{{ω}_{{CR}_{y}} {τ}_{y}}} ;$$
$${ζ}_{0 y} = \frac{1}{2} {ω}_{0 y} ( 2 \frac{{ζ}_{y}}{{ω}_{y}} + {τ}_{y} - \frac{{ω}_{{AF}_{y}}^{2}}{{ω}_{C {R}_{y}} {ω}_{0 y}^{2}} ) ;$$
$${K}_{0 y} = - \frac{{ω}_{y}^{2}}{{τ}_{y} {ω}_{A {F}_{y}}^{2}} ;$$
$${K}_{Cy} = \frac{2 {ζ}_{0 y} {ω}_{0 y} {T}_{3 y} - \frac{{ω}_{0 y}^{2}}{{ω}_{yy}^{2}} - 1}{1 - 2 {ζ}_{0 y} {ω}_{0 y} {T}_{3 y} + {T}_{3 y}^{2} {ω}_{0 y}^{2}} ;$$
step 7: select the controller at the initialization point based on the criteria defined in step 5, at the end of step 7, the controller at the initialization point is obtained, denoted as:
$${q}_{0} = [ {K}_{{DC}_{0}} , {K}_{{A}_{0}} , {K}_{{I}_{0}} , {K}_{{R}_{0}} ]$$
part II: determine an adaptive controller based on a required velocity, altitude, and load factor; this part is implemented in MATLAB after the initialization controller has been defined in part I, steps are as follows:
step 1: select a set of design points across a full operating range of the FO; select j₁ velocity points within an interval [V₁, V₂], denoted as Vₐᵣᵣ; select j₂ altitude points within an interval [h₁, h₂], denoted as harr; select j₃ load factor points within an interval [n₁, n₂], denoted as nₐᵣᵣ; use a ndgrid command to generate a 3D array of design points:
$$[ V , h , n ] = ndgrid ( {V}_{arr} , {h}_{arr} , n\_arr )$$
use a struct command to create the grid of design points:
$$TuningGrid = struct ( ‘ V ’ , V , ‘ h ’ , h , ‘ n ’ , n )$$
step 2: linearize the FO model at the design points; perform this step in the same manner as step 4 of part I, but now apply it to all design points, the result is an array of linearized models, denoted as G;
step 3: create an interface between the FO model and the controller; use a slTuner command to create an interface that replaces the FO model with an array of linear models; the slTuner interface connects the controller coefficients to form a closed-loop model corresponding to each design point; first, define a substitution structure using the struct command:
$$BlockSubs = struct ( ‘ Name ’ , ‘ AP / M ô h ì nh TBB ’ , ‘ Value ’ , G$$
$$ST 0 = slTuner ( AP , \{ ‘ {K}_{DC} ’ , ‘ {K}_{DC} ’ , ‘ {K}_{I} ’ , ‘ {K}_{R} ’ \} , BlockSubs )$$
step 4: model the adaptive variables as a parametric surface; a chosen adaptive function is a three-variable function of the form:
$$K ( V , n , h ) = {K}_{0} + {K}_{1} * V + {K}_{2} * n + {K}_{3} * h + {K}_{4} * V * n + {K}_{5} * V * h …$$
where:
V is flight velocity, n is a required load factor, h is a flight altitude;
K₀ is the initialization controller coefficient, calculated from part I;
Kᵢ(i=1̅,̅2̅,̅ .̅ .̅ .̅ ) are the coefficients to be computed and tuned;
the parametric surface is written as:
$$shapeFcn = @ ( V , h , n ) [ V , h , n , V * n , V * h ]$$
then, create tunable surfaces using a tunableSurface command to establish parametric gain surface:
$${K}_{DC} = tunableSurface ( ‘ {K}_{DC} ’ , {K}_{{DC}_{0}} , TuningGrid , ShapeFcn )$$
$${K}_{A} = tunableSurface ( ‘ {K}_{A} ’ , {K}_{{A}_{0}} , TuningGrid , ShapeFcn )$$
$${K}_{I} = tunableSurface ( ‘ {K}_{I} ’ , {K}_{{I}_{0}} , TuningGrid , ShapeFcn )$$
$${K}_{R} = tunableSurface ( ‘ {K}_{R} ’ , {K}_{{R}_{0}} , TuningGrid , ShapeFcn )$$
set values for control gains using a setBlockParam command:
$$ST 0. setBlockParam ( {‘ K ’}_{DC} , {K}_{DC} , {‘ K ’}_{A} , {K}_{A} , {‘ K ’}_{I} , {K}_{I} , {‘ K ’}_{R} , {K}_{R} )$$
step 5: determine control criteria for all design points; these criteria can either remain the same as those defined in step 5 of part I or be customized depending on the controller's performance at the set of design points; however, in part II, the control criteria are divided into two types: hard constraint and soft constraint; hard constraints are mandatory and must be satisfied at all design points; soft constraints can be adjusted to achieve the highest possible level of satisfaction across all points; all design points may share the same set of control criteria, or specific criteria can be defined for each individual point, a TuningGoal command is used to define the control objectives;
step 6: adjust the controller coefficients; by using a systune command, the controller coefficients are tuned through an optimization algorithm based on the defined control criteria; the result is a controller represented by surfaces of the four main gains K_{DC}, K_{A}, K_{I}, K_{R}:
$$ST = systune ( ST 0 , Req 1 , Req 2 )$$
where Req1 is the soft constraints (defined first), and Req2 is the hard constraints (defined later);
step 7: evaluate control performance; the evaluation of controller performance includes the following steps:
check resulting parametric gain surfaces to ensure there are no singularities or discontinuities; use a getBlockParam command to decode the controller coefficients:
$$TGS = getBlockParam ( ST )$$
plot the parametric surfaces using a viewSurf command:
```
viewSurf (TGS. K_{DC})
  viewSurf (TGS. K_{A})
  viewSurf (TGS. K_{I})
  viewSurf (TGS. K_{R})
```
from the generated surfaces, check that a curvature is smooth and continuous, without folds or singular points;
visualize design objectives at all design points before and after tuning; use a viewGoal command to inspect system responses before and after controller tuning;
evaluate control effectiveness between design points by adding intermediate points; if performance is not maintained, these intermediate points can be added to the set of design points, and controller coefficients should be re-tuned accordingly; this step requires the use of specialized software for evaluating the control performance of the FO;
assess control performance on a nonlinear simulation model by designing ideal test scenarios and conducting Monte Carlo simulations to assess the robustness of the controller; this step requires simulation software capable of modeling the FO dynamics;
if any of the four steps above fail, consider revising the selection of adaptive variables, the adaptive function, or the set of design points.
